(19) United States
(12) Patent Application Publication
(10) Pub. No.: US 2021/0171082 A1
(43) Pub. Date: Jun. 10, 2021

(54) WHEEL ADAPTER FOR PROVIDING ROLLING MOBILITY TO A CARGO CONTAINER

(71) Applicants: Frederick W. Anton Engelbrecht, Mars Hill, NC (US); Richard Alan Stahl, Englewood, FL (US); Marshall Roy Crosby, Jonesboro, GA (US)

(72) Inventors: Frederick W. Anton Engelbrecht, Mars Hill, NC (US); Richard Alan Stahl, Englewood, FL (US); Marshall Roy Crosby, Jonesboro, GA (US)

(21) Appl. No.: 16/382,744

(22) Filed: Apr. 12, 2019

Related U.S. Application Data
(63) Continuation-in-part of application No. 15/594,037, filed on May 12, 2017, now Pat. No. 10,336,135.
(60) Provisional application No. 62/336,011, filed on May 13, 2016.

(51) Int. Cl. B62B 5/00; B60B 33/06; B60B 33/00

(52) U.S. Cl. CPC B62B 5/0086; B60B 33/06; B60B 33/0049; B60B 33/0042; B60B 33/0063

(57) ABSTRACT

A wheel adapter for connecting to a cargo container and providing the cargo container with rolling mobility. The wheel adapter includes an adapter body, one or more wheels rotatable with respect to the adapter body, and a container connector extending from the adapter body for connection to the cargo container. A pusher mechanism engages the adapter body and can be operated to move the adapter body relative to the wheel or wheels in order to vary the vertical placement of the wheel(s) in relation to the container connector. For example, the pusher mechanism can include a wheel-displacement bolt for translationally moving the wheel(s) upward and downward with respect to the container connector, and/or an airbag unit for pivoting the adapter body in relation to the wheel(s) and thus lowering or raising the wheel(s) with respect to the container connector.

### CROSS-REFERENCE TO RELATED APPLICATIONS

This application is a Continuation-In-Part Utility Patent application claiming priority to U.S. Utility patent application Ser. No. 15/594,037, filed on May 12, 2017, which in turn claims the benefit of U.S. Provisional patent Application Ser. No. 62/336,011, filed on May 13, 2016, both of which are incorporated by reference herein in their entirety.

### FIELD OF THE INVENTION

The present invention relates generally to cargo containers, and more particularly, to a wheel adapter for a cargo container which can be attached to a cargo container to impart a rolling mobility to the cargo container.

### BACKGROUND OF THE INVENTION

Shipping containers, also known as cargo containers, are used to load cargo onto and unload the cargo from a ship, truck, train or other means of transportation, and to carry the cargo in an organized and relocatable manner on a means of transportation. For example, intermodal containers are large standardized shipping containers used to transport cargo using different modes of transport without the requirement of unloading and reloading the cargo. ISO containers are an example of intermodal containers.

Conventional cargo containers typically include a floor, walls extending from the floor and a roof on the walls. One or more doors may be provided in the walls of the containers. Containers can also typically include fasteners, or fastening portions to which fasteners can be coupled, to allow securing the containers during loading, unloading and transportation. For instance, ISO containers include eight ISO connectors, one at each corner of the container, for attaching ISO compliant fasteners.

When loaded with cargo, a cargo container may be sufficiently heavy to require machinery for transport. Accordingly, forklifts, cranes or other machinery are commonly used to transport the containers over short distances such as onto and from a means of transportation or among various locations in a storage facility. In some applications, however, forklifts, cranes or other machinery may not be available or may be in limited supply, particularly in the event that a large number of cargo containers require movement over short distances.

Ideally, it would be extremely useful to be able to attach a set of wheels to a container. However, a forklift, crane or other machinery is envisaged as still being necessary to lift the container and allow attaching the set of wheels to the container.

Accordingly, there is an established need for a preferably wheeled device or apparatus that imparts short-range mobility to the cargo container, and yet does not require the use of a crane, forklift or other complex machinery to install or utilize the device.

### SUMMARY OF THE INVENTION

The present invention is directed to a wheel adapter for connecting to a cargo container and providing the cargo container with rolling mobility. The wheel adapter includes an adapter body, one or more wheels rotatable with respect to the adapter body, and a container connector extending from the adapter body for connection to the cargo container. A pusher mechanism engages the adapter body and is operable to move the adapter body relative to the wheel or wheels in order to vary the vertical placement of the wheel(s) in relation to the container connector. For example, the pusher mechanism can include a wheel-displacement bolt for translationally moving the wheel(s) upward and downward with respect to the container connector, and/or an airbag unit for pivoting the adapter body in relation to the wheel(s) and thus lowering or raising the wheel(s) with respect to the container connector. Accordingly, in an exemplary application, a respective wheel adapter can be attached to each side of the cargo container. The pusher mechanism of each wheel adapter can be operated to selectively raise the container and facilitate rolling displacement of the container along a floor or support surface.

In a first implementation of the invention, a wheel adapter for lifting a cargo container and providing rolling mobility to the cargo container comprises an adapter body. A container connector is carried by and extends outward from the adapter body. The container connector is configured for connection to a cargo container. The wheel adapter further includes at least one wheel, rotatable relative to the adapter body, and a pusher mechanism engaging the adapter body. The wheel adapter is configured to selectively and reversibly adopt a first position and a second position by operating the pusher mechanism. In the first position, the bottom of the at least one wheel is at a first vertical position relative to the container connector. In the second position, the bottom of the at least one wheel is at a second vertical position relative to the container connector which is lower than the first vertical position, and the bottom of the at least one wheel contacts a ground or support surface.

In a second aspect, the container connector can be pivotably attached to the adapter body.

In another aspect, the container connector can be non-movably attached to the adapter body.

In another aspect, the at least one wheel can be rotatably coupled to and carried by a wheel support. The wheel support can be translationally movable relative to the adapter body and coupled to the pusher mechanism such that operation of the pusher mechanism causes the wheel adapter to switch between the first and second positions by translationally moving the wheel support and at least one wheel relative to the adapter body.

In another aspect, the at least one wheel may be suspended from the pusher mechanism when the wheel adapter is in the first position.

In yet another aspect, the pusher mechanism can include a wheel-displacement bolt threadably engaging the adapter body and comprising a bolt head for the application of a torque on the bolt head to rotate the wheel-displacement bolt.

In another aspect, the bolt head is preferably accessible and operable from outside the wheel adapter.

In another aspect, the wheel-displacement bolt can be registered with the at least one wheel such that threading the wheel-displacement bolt into the adapter body pushes the at least one wheel downward relative to the container connector to switch the wheel adapter to the second position.

In another aspect, the wheel-displacement bolt can be coupled to the at least one wheel such that unthreading (i.e. reverse threading) the wheel-displacement bolt from the adapter body elevates the at least one wheel relative to the container connector to switch the wheel adapter to the first position.

In yet another aspect, the container connector may be pivotably attached to the adapter body about a first rotation axis. In turn, the at least one wheel may be rotatably carried by the adapter body about a second rotation axis arranged rearward of and parallel to the first rotation axis. The wheel-displacement bolt can be arranged frontward of the first rotation axis and configured to be threaded into the adapter body to push against the container connector and cause the adapter body to pivot about the first rotation axis such that the at least one wheel responsively descends in relation to the container connector to switch the wheel adapter to the second position.

In another aspect, the adapter body can include a first adapter body portion extending upward from a rotation axis of the at least one wheel, and a second adapter body portion extending frontward of the rotation axis of the at least one wheel. The pusher mechanism can be carried by the first adapter body portion and the container connector can be carried by the second adapter body portion.

In another aspect, the pusher mechanism can include an inflatable and deflatable airbag unit arranged in contact with the adapter body. The wheel adapter may be configured to adopt the second position by inflating the airbag unit such that the airbag unit pushes and causes rotation of the adapter body relative to the at least one wheel, thereby causing the container connector to rotate carried by the adapter body and to elevate relative to the at least one wheel.

In another aspect, the wheel-displacement bolt can be configured to push the at least one wheel set downward thereby increasing separation between the airbag unit and the bottom of the at least one wheel.

In yet another aspect, the wheel-displacement bolt may also be configured to pull the at least one wheel set upward thereby decreasing separation between the airbag unit and the bottom of the at least one wheel.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an exploded isometric view of a pair of wheel adapters connected to a respective pair of ISO connectors on an ISO cargo container in accordance with a first illustrative embodiment of the present invention;

FIG. 2 presents an exploded isometric view of one of the wheel adapters illustrated in FIG. 1;

FIG. 3 presents an exploded isometric view of the wheel adapter illustrated in FIG. 2, with the container connector in an assembled configuration;

FIG. 4 presents an isometric view of the partially-assembled wheel adapter, more particularly illustrating typical attachment of a wheel to the wheel axle;

FIG. 5 presents an isometric view of the wheel adapter in a first position, in which the wheels are elevated relative to the adapter housing, more particularly illustrating rotation of the wheel-displacement bolt to elevate the adapter housing;

FIG. 6 presents an isometric view of the wheel adapter in a second position, in which the wheels are lowered relative to the adapter housing;

FIG. 7 presents a cross-sectional side elevation view of the wheel adapter in the first position of FIG. 5, further illustrating the ISO container;

FIG. 8 presents a cross-sectional side elevation view of the wheel adapter in the second position of FIG. 6, further illustrating the ISO container;

FIG. 9 presents a side elevation view of the wheel adapter on the cargo container (shown only partially), with the wheel adapter in the first position of FIG. 5;

FIG. 10 presents a side elevation view of the wheel adapter on the cargo container, with the wheel adapter in the second position of FIG. 6;

FIG. 11 presents an exploded isometric view of a pair of wheel adapters connected to a respective pair of ISO connectors on an ISO cargo container in accordance with a second illustrative embodiment of the present invention;

FIG. 12 presents an exploded isometric view of one of the wheel adapters illustrated in FIG. 11;

FIG. 13 presents a partially-exploded isometric view of the wheel adapter illustrated in FIG. 12, with the container connector in exploded view and the wheel assembled;

FIG. 14 presents a partially-exploded isometric view of the wheel adapter illustrated in FIG. 12, more particularly illustrating typical engagement of the wheel-displacement bolt with the adapter housing;

FIG. 15 presents an isometric view of the wheel adapter of FIG. 12 in a first position, in which the wheel is elevated relative to the container connector, more particularly illustrating rotation of the wheel-displacement bolt to elevate the adapter housing;

FIG. 16 presents an isometric view of the wheel adapter of FIG. 12 in a second position, in which the wheel is lowered relative to the container connector;

FIG. 17 presents a cross-sectional side elevation view of the wheel adapter in the first position of FIG. 15, further illustrating the ISO container;

FIG. 18 presents a cross-sectional side elevation view of the wheel adapter in the second position of FIG. 16, further illustrating the ISO container;

FIG. 19 presents a side elevation view of the wheel adapter of FIG. 12 on the cargo container (shown only partially), with the wheel adapter in the first position of FIG. 15;

FIG. 20 presents a side elevation view of the wheel adapter of FIG. 12 on the cargo container, with the wheel adapter in the second position of FIG. 16;

FIG. 21 presents an exploded top front isometric view of a pair of wheel adapters connected to a respective pair of ISO connectors on an ISO cargo container in accordance with a third illustrative embodiment of the present invention;

FIG. 22 presents a top rear isometric view of one of the wheel adapters illustrated in FIG. 21;

FIG. 23 presents an exploded top rear isometric view of the wheel adapter illustrated in FIG. 22;

FIG. 24 presents an exploded bottom front isometric view of the wheel adapter illustrated in FIG. 22;

FIG. 25 presents a side elevation view of the wheel adapter of FIG. 22, the wheel-displacement bolt in a threaded position that causes the wheel to be translationally displaced downward and lowered in relation to the container connector;

FIG. 26 presents a top plan view of the wheel adapter of FIG. 25, indicating the section plane used to generate the cross-sectional side elevation views of FIGS. 27-29;

FIG. 27 presents a cross-sectional side elevation view of the wheel adapter of FIG. 22 attached to a cargo container, the wheel adapter shown in a first position in which the wheel-displacement bolt is unthreaded from the adapter body, the wheel is raised from the ground, and the airbag unit is deflated, the figure further illustrating the cargo container resting on the ground;

FIG. 28 presents a cross-sectional side elevation view of the wheel adapter and cargo container of FIG. 27 in a second position, in which the wheel-displacement bolt is threaded into the adapter body, the wheel is pushed by the bolt to contact the ground, and the airbag unit remains deflated, with the cargo container still resting on the ground;

FIG. 29 presents a cross-sectional side elevation view of the wheel adapter and cargo container of FIG. 27 in a third position, in which the wheel-displacement bolt is threaded into the adapter body, the wheel continues to rest on the ground, and the airbag unit is inflated causing the adapter body to pivot relative to the wheel and the container connector to responsively ascend relative to the wheel, thereby elevating the cargo container from the ground;

FIG. 30 presents a side elevation view of the wheel adapter and cargo container in the position of FIG. 28; and

FIG. 31 presents a side elevation view of the wheel adapter and cargo container in the position of FIG. 29.

Like reference numerals refer to like parts throughout the several views of the drawings.

### DETAILED DESCRIPTION

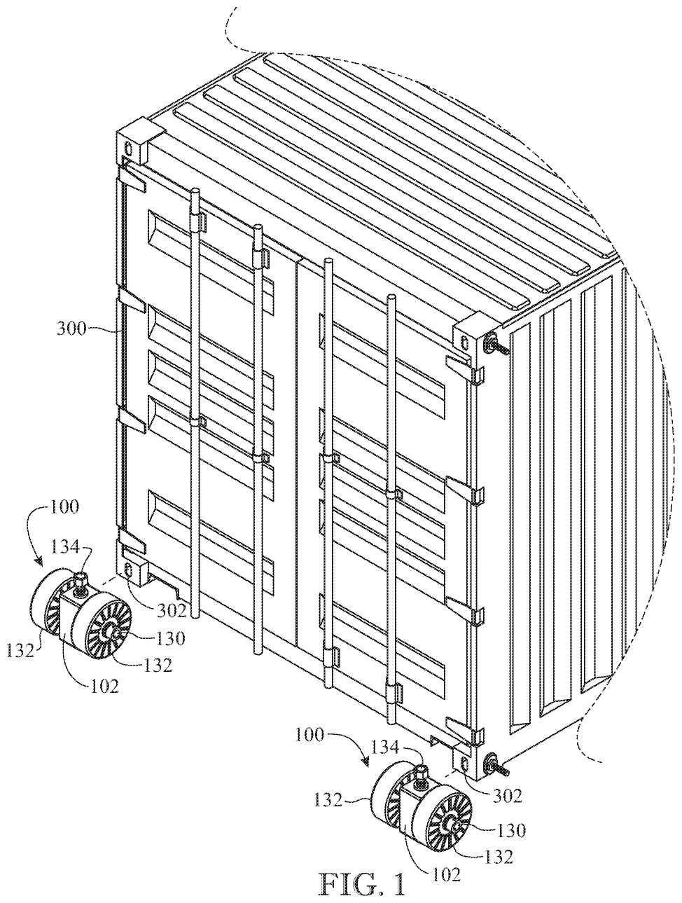

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a wheel adapter which can be attached to a cargo container to impart a rolling mobility to the cargo container.

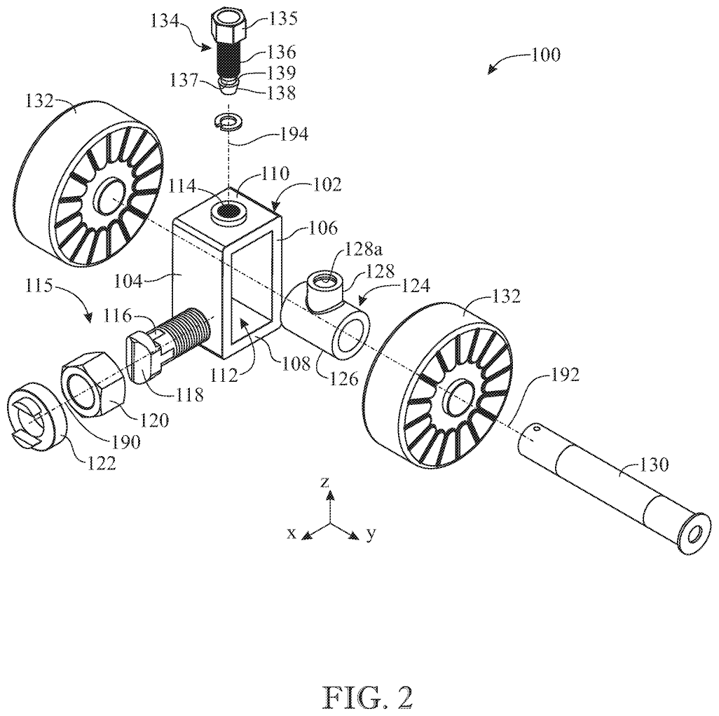

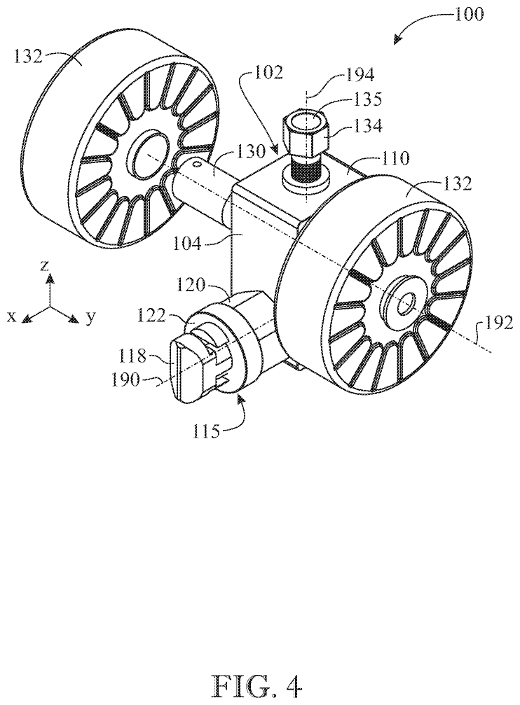

Referring initially to FIGS. 1-10, a wheel adapter for a cargo container, hereinafter wheel adapter 100, is illustrated in accordance with a first exemplary embodiment of the present invention. As shown for instance in FIG. 2, the wheel adapter 100 includes an adapter housing or body 102. In some embodiments, the adapter body 102 may include a front wall 104, a rear wall 106, a bottom wall 108, a top wall 110 and a housing interior 112. An interiorly-threaded bolt opening 114 extends through the top wall 110. By interiorly-threaded, it is understood that the bolt opening 114 provides a female threaded connection.

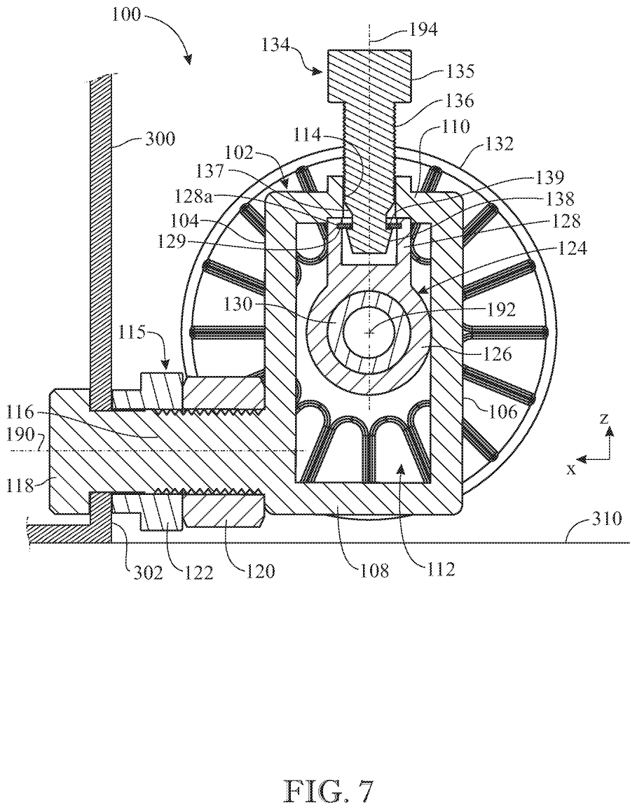

A container connector 115 may extend outward from the adapter body 102 in a front-to-back, longitudinal direction x along a central axis 190 of the container connector 115. The container connector 115 is configured to attach the wheel adapter 100 to a cargo container; for instance and without limitation, the container connector 115 can be configured for connection to a standard ISO connector 302 on an ISO cargo container 300, shown for example in FIG. 1. As illustrated in FIGS. 2 and 7, in some embodiments, the container connector 115 may include a container coupling bolt 116 and a bolt head 118. The container coupling bolt 116 may extend from the front wall 104 of the adapter body 102 in a non-movable relationship with the front wall 104 of the adapter body 102. In some embodiments, as shown in the figures, the container coupling bolt 116 may be integrally formed with the adapter body 102 into a single-piece unit; in other embodiments, the container coupling bolt 116 may be formed as a separate unit and non-movably attached to the adapter body 102, such as by welding. A regular nut 120 and a lock nut 122 may be threaded on the container coupling bolt 116. The regular nut 120 and the lock nut 122 facilitate coupling of the container coupling bolt 116, and thus the adapter body 102, to the cargo container 300.

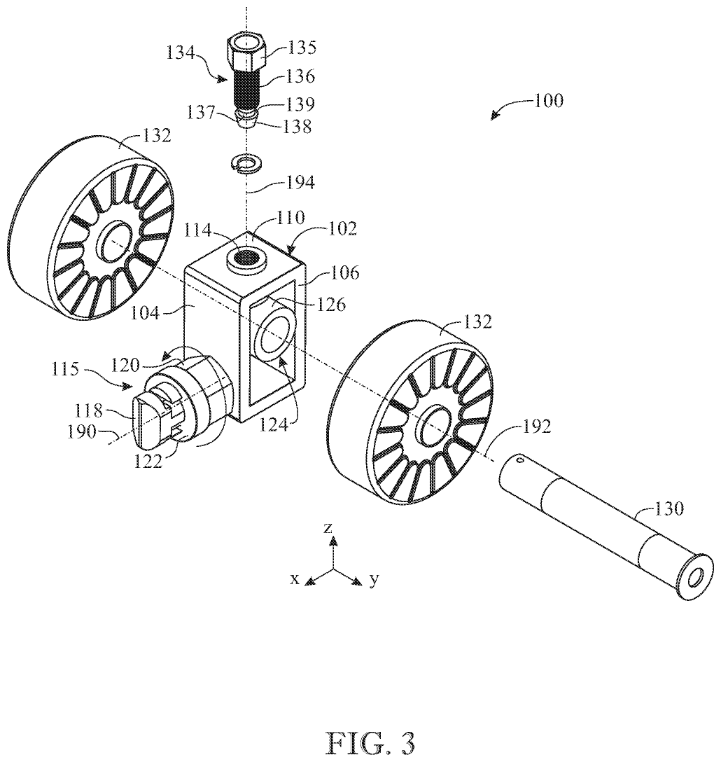

A wheel axle 130 may be formed along a central axis 102 and extend through the adapter body 102. The wheel axle 130 and central axis 192 are arranged preferably in a left-to-right, transverse direction y which is perpendicular to the longitudinal direction x. A pair of wheels 132 may be provided on the wheel axle 130. The wheel axle 130 may be mounted in the adapter body 102. As illustrated in FIGS. 2 and 3, in some embodiments, an axle coupling 124 may be disposed in the housing interior 112 of the adapter body 102. The axle coupling 124 may be generally T-shaped with an axle receiving portion 126 extending along the transverse direction transverse direction y and about the same central axis 192 as the wheel axle 130, and an interiorly-non-threaded, cylindrical bolt receiving portion 128 which can extend upward from a central portion of the axle receiving portion 126 along a central axis 194 which is preferably arranged in a lateral direction z perpendicular to the longitudinal and transverse directions x and y. A C-clip 129 is non-movably secured to the bolt receiving portion 128 (fitted into a recess 128a provided in an inner wall of the bolt receiving portion 128) for purposes that will be described hereinafter. The axle receiving portion 126 is shaped and sized to receive the wheel axle 130 therethrough. The axle receiving portion 126 and wheel axle 130 jointly provide a wheel support, for rotatably supporting the wheels 132. The wheels 132 are configured to rotate freely in relation to the housing 102; for instance and without limitation, the wheels 132 can be rotatably coupled to the wheel axle 130 or the wheel axle 130 can be rotatably coupled to the axle receiving portion 126 by ball bearings or other suitable techniques known by those skilled in the art. When the wheel adapter 100 is assembled, the wheel axle 130 extends through the axle receiving portion 126, and the bolt receiving portion 128 aligns or registers with the bolt opening 114 for purposes which will be hereinafter described.

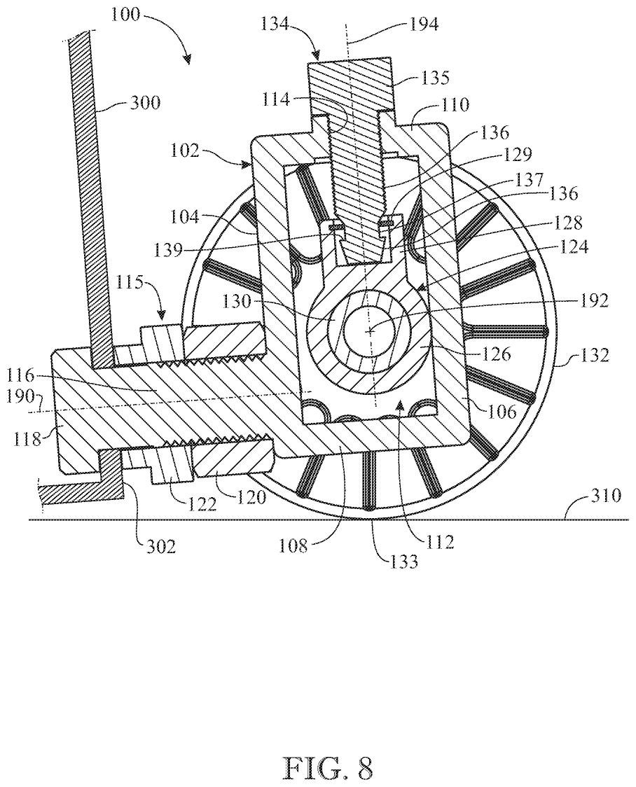

As particularly illustrated in FIGS. 7 and 8, a pusher mechanism or wheel-displacement bolt 134 may be threaded to the bolt opening 114, into the adapter body 102 and inserted into the bolt receiving portion 128 of the axle coupling 124. The wheel-displacement bolt 134 includes a bolt head 135 which is accessible and operable from outside the wheel adapter 100, and more preferably arranged outside the adapter body 102 to facilitate the coupling of a torque-applying tool or device (not shown) onto the bolt head 135. The wheel-displacement bolt 134 further includes a threaded shaft 136, a partially-conical and partially-cylindrical neck portion 137 which is narrower than and extends from the threaded shaft 136, and a conical end portion 138 which extends from and end of the neck portion 137 and is wider than said end of the neck portion 137 and preferably narrower than the threaded shaft 136. A stop surface 189 of the end portion 138 extends radially from said end of the neck portion 137, as best shown in FIGS. 2 and 7. The wheel-displacement bolt 134 is movably received in the bolt receiving portion 128, and is able to move within the bolt receiving portion 128 both axially (along central axis 194) and rotationally (about central axis 194). The axial movement of the wheel-displacement bolt 134 relative to the bolt receiving portion 128 is limited by the C-clip 129. The wheel-displacement bolt 134 is registered with the wheels 132 such that threading the wheel-displacement bolt 134 into the adapter body 102 pushes the wheels 132 downward for purposes that will be hereinafter described.

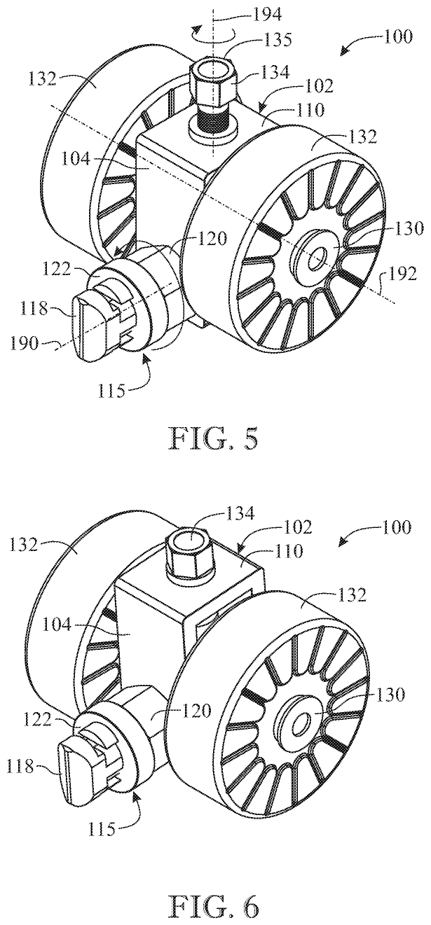

In some embodiments, as shown in FIG. 7, a central longitudinal axis of the wheel-displacement bolt 134 (arranged in the lateral direction z) may be vertically aligned with a central longitudinal axis of the wheel axle 130 (arranged in the transverse direction y). The axle coupling 124 is movable laterally (i.e. in the lateral direction z) within and in relation to the adapter body 102. As will be described in greater detail hereinafter, by adjusting the degree of threading and insertion of the wheel-displacement bolt 134 into the bolt opening 114 of the adapter body 102, the lateral position of the axle coupling 124 relative to the adapter body 102 and container connector 115 is adjusted, thereby adjusting the vertical position of the wheel axle 130 relative to the adapter body 102 and container connector 115. For instance, the axle coupling 124 and wheel axle 130 can be selectively deployed in a first or elevated position relative to the container connector 115, as illustrated in FIGS. 5 and 7, typically by counterclockwise threading of the wheel-displacement bolt 134 in the bolt opening 114 of the adapter body 102; accordingly, the housing 102 and container connector 115 are deployed in a lowered position relative to the axle coupling 124 and wheel axle 130. Alternatively, the axle coupling 124 and wheel axle 130 can be selectively deployed in a second or lowered position relative to the container connector 115, as illustrated in FIGS. 6 and 8, typically by clockwise threading of the wheel-displacement bolt 134 in the bolt opening 114 of the adapter body 102; accordingly, the housing 102 and container connector 115 are deployed in an elevated position relative to the axle coupling 124 and wheel axle 130, and the wheel 132 is in a lowered position in which a bottom end of the wheel provides a bottom end of the wheel adapter 100. Although not shown, intermediate positions are possible, by only partially threading the wheel-displacement bolt 134 into the adapter body 102.

As illustrated in FIGS. 1 and 7-10, in typical application, two or more wheel adapters 100 are attached to a cargo container 300 to facilitate rolling mobility of the cargo container 300 on a support surface 310. The cargo container 300 may be a standard shipping container known in the art including but not limited to a standard ISO shipping container, as shown in the drawings. As best shown in FIG. 1, a standard ISO connector 302 is provided on each of the six corners of the standard ISO cargo container 300 as known in the art. In some applications, four wheel adapters 100 in accordance with the invention can be respectively attached to the four bottom corners of the cargo container 300; in other applications, such as that of FIG. 1, only two wheel adapters 100 can be connected to two opposed bottom ISO connectors 302 of the cargo container 300. The container connector 115 of each wheel adapter 100 couples with the companion ISO connector 302 to facilitate attachment of the wheel adapters 100 to the cargo container 300. Standard ISO connectors 302 are highly resistant to cargo weight and pulling and pushing forces on the cargo container 300. Therefore, because the wheel adapter 100 typically connects to the standard ISO connector 302 on the cargo container 300, the connection between the wheel adapter 100 and the cargo container 300 is particularly robust.

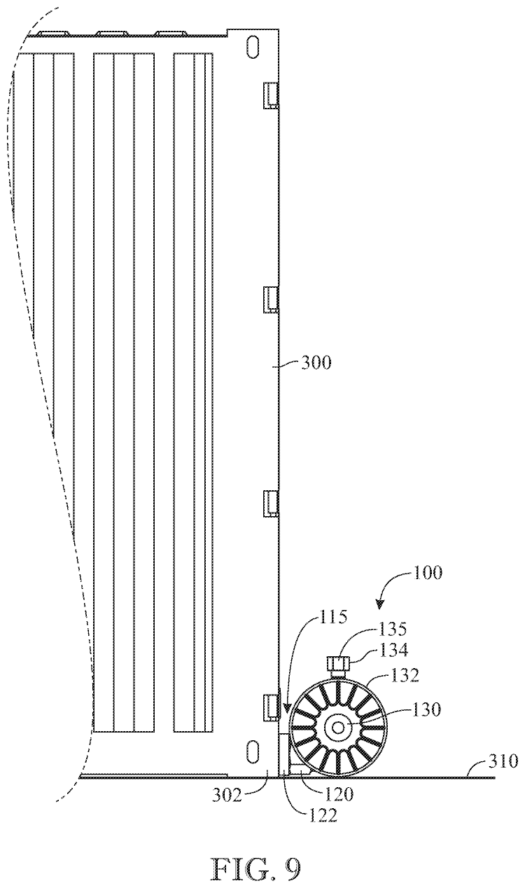

As illustrated in FIGS. 7 and 9, each wheel adapter 100 may initially be deployed in a first position with the cargo container 300 resting on the support surface 310. In this first position, the wheel-displacement bolt 134 has been threaded in the counterclockwise direction relative to the bolt opening 114 of the adapter body 102, as illustrated in FIGS. 5 and 7, and threaded out of the adapter body 102 in an upward direction. During the unthreading and rising of the wheel-displacement bolt 134, the stop surface 139 of the end portion 138 of the wheel-displacement bolt 134 has risen and contacted C-clip 129 and exerted an upward traction force on the C-clip 129, causing the C-clip 129, axle coupling 124, wheel axle 130 and wheels 132 to jointly rise, suspended from the wheel-displacement bolt 134. In the first position of FIGS. 5 and 7, the wheel-displacement bolt 134 is sufficiently unthreaded from the adapter body 102 to position the wheels 132 in an elevated position relative to the support surface 310.

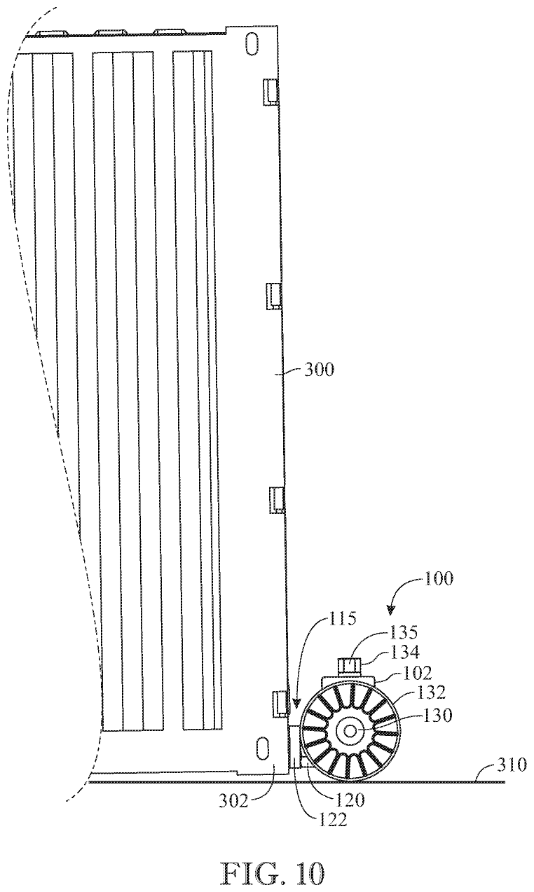

From this first position, a torque may be applied on the bolt head 135 of the wheel-displacement bolt 134 in the clockwise direction to thread the wheel-displacement bolt 134 into the bolt opening 114 of the adapter body 102. Threading the wheel-displacement bolt 134 into the adapter body 102 causes the wheel-displacement bolt 134 and the components that are suspended from the wheel-displacement bolt 134 (i.e. the C-clip 129, axle coupling 124, wheel axle 130 and wheels 132) to jointly descend (translationally move downward), eventually causing the wheels 132 to reach the support surface 310. Once the wheels 132 have contacted the support surface 310, this contact prevents the wheels 132, wheel axle 130, axle coupling 124 and wheel-displacement bolt 134 from moving further downwards; thus, further continued threading of the wheel-displacement bolt 134 into the adapter body 102 causes the bolt opening 114 (and thus the adapter body 102) to displace upward with respect to the wheel-displacement bolt 134 as the wheel-displacement bolt 134 rotates but no longer moves axially downward. In consequence, the container connector 115 (which is affixed to the adapter body 102) and the cargo container 300 (which is attached to the container connector 115) are caused to jointly move upward relative to the wheels 132, wheel axle 130, axle coupling 124 and wheel-displacement bolt 134, lifting the cargo container 300 off the support surface 310. The illustrations of FIGS. 8 and 10 show the wheel adapter 100 in a second position, in which the wheel-displacement bolt 134 has been threaded as deeply as possible into the adapter body 102 and the bolt head 135 rests against the adapter body 102, and the cargo container 300 significantly lifted from the support surface 310. In this second position, a bottom end of the wheel-displacement bolt 134 opposite the bolt head 135 is received in the bolt receiving portion 128, ensuring that the wheel-displacement bolt 134 remains in correct alignment with the axle coupling 124 and wheel axle 130 regardless of longitudinal or transverse forces which may be exerted on the wheel-displacement bolt 134 or other components of the wheel adapter 100; more specifically, when aligned, the central axis 194 of the wheel-displacement bolt 134 is preferably coplanar to the central axis 192 of the wheel axle 130. Furthermore, in this second position, the bottom end 133 of the wheel 132 rests on the support surface 310. This lifting sequence can be repeated on a wheel adapter 100 affixed to an opposite corner of the cargo container 300. The raised cargo container 300 can be transported on the support surface 310 typically by lifting an opposite end of the cargo container 300 and pulling or pushing the cargo container 300 as the two wheels 132 roll on the support surface 310. Alternatively, the lifting sequence can be repeated on wheel adapters 100 provided on all four bottom corners of the cargo container 300, to completely lift the cargo container 300 to become supported on four wheels 132 and allow the cargo container 300 to be displaced by pulling or pushing the cargo container 300 as the four wheels 132 roll on the support surface 310. In this manner, the cargo container 300 can be easily moved, such as from a cargo storage area onto a transport vehicle, from the transport vehicle to the cargo storage area or from one place to another within a lot.

After the cargo container 300 has arrived at the intended destination, the wheel adapters 100 can again be operated to the first position of FIGS. 5, 7 and 9 typically by counterclockwise rotation of the head 135 of the wheel-displacement bolt 134 relative to the adapter body 102 and the axle coupling 124 of each corresponding wheel adapter 100. This action lowers the cargo container 300 back onto the support surface 310, as illustrated in FIG. 9. In some applications, the wheel adapters 100 can be detached from the cargo container 300 by uncoupling the container connectors 115 on the respective wheel adapters 100 from the respective ISO connectors 302 (FIG. 1) on the cargo container 300. Alternatively, in some applications, the wheel adapters 100 may remain in place on the cargo container 300 in anticipation of further transport requirements.

In summary, a cargo container wheel adapter 100 is provided which can elevate a cargo container 300 and provide a wheeled support by simply operating a wheel-displacement bolt 134. In dependence of the degree to which the wheel-displacement bolt 134 is threaded into the adapter body 102 (i.e. the bolt opening 114), the vertical position of the adapter body 102 in relation to the wheels 132 can be adjusted. Thus, by adjusting the wheel-displacement bolt 134, the cargo container 300 can be lifted from or lowered onto a support surface 310, and can be supported or not on the wheels 132.

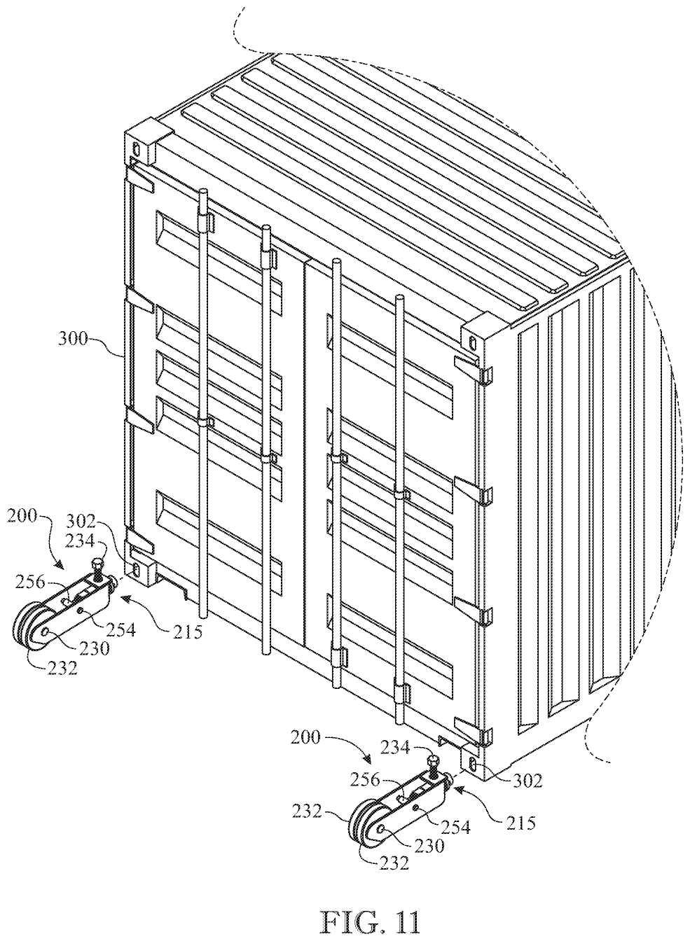

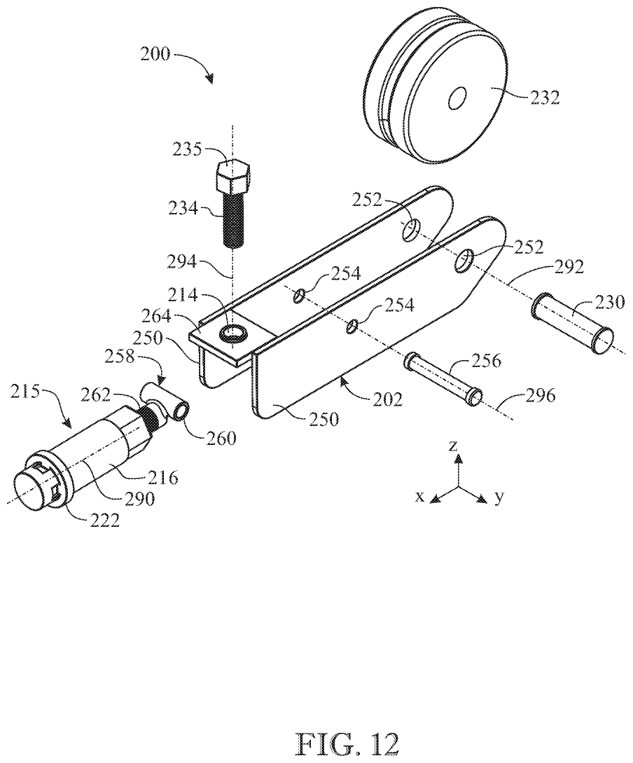

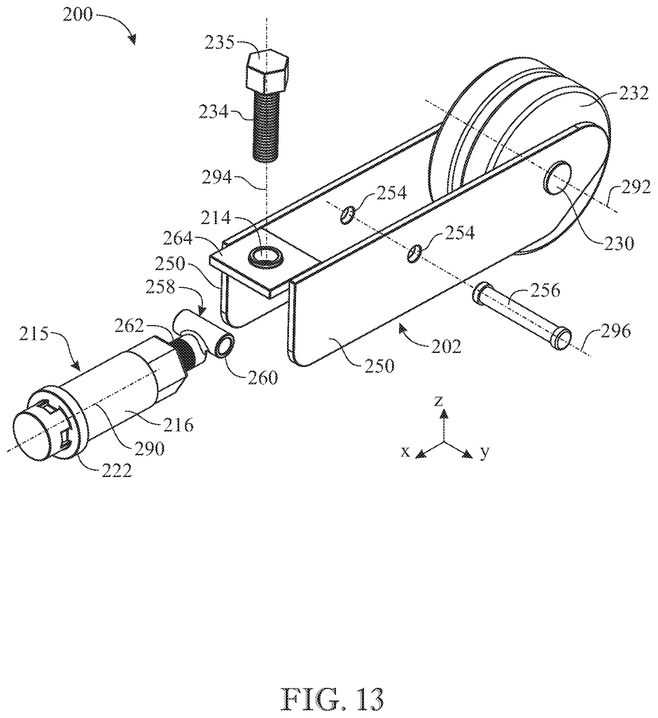

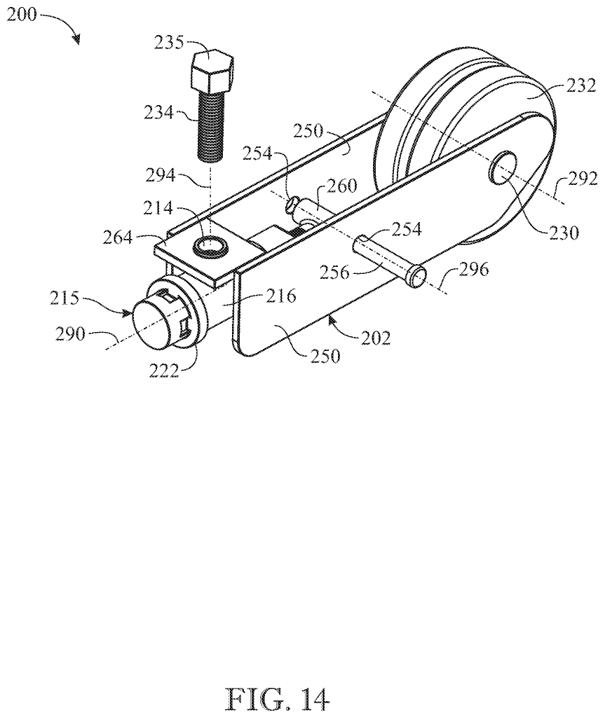

Referring next to FIGS. 11-20, a wheel adapter 200 is shown in accordance with a second illustrative embodiment of the invention. Reference numerals which correspond to like elements of the wheel adapter 100 heretofore described with respect to FIGS. 1-10 are designated by the same reference numerals in the 200-299 series in FIGS. 11-20. As illustrated in FIG. 12, the adapter housing or body 202 of the wheel adapter 200 may include a pair of generally elongated, parallel, spaced-apart side plates 250 arranged in a front-to-back, longitudinal direction z, and a connecting plate 264 extending between the side plates 250 at a front end of the adapter body 202. A bolt opening 214 may extend through the connecting plate 264. A pusher mechanism, constituted by a wheel-displacement bolt 234 formed along a central axis 294, threadably engages the bolt opening 214 and is threadingly movable along a lateral direction z perpendicular to the longitudinal direction x. The wheel-displacement bolt 234 includes a bolt head 235 which is accessible and operable from outside the wheel adapter 200.

A pair of wheel axle openings 252 may extend through the side plates 250 at a rear end of the adapter body 202. The wheel axle openings 252 are aligned or in registration with one another along a left-to-right, transverse direction y perpendicular to the longitudinal and lateral directions x and z. A wheel axle 230, formed along a central axis 292, may extend through the wheel axle openings 252 and in the transverse direction y. A wheel 232 may be mounted for rotation on the wheel axle 230 between the side plates 250 of the adapter body 202.

A container connector 215, formed along a central axis 290, is pivotally connected to the adapter body 202 and protrudes outward from the front end of the adapter body 202. The container connector 215 is pivotally mounted between the side plates 250 of the adapter body 202. For instance and without limitation, as illustrated in FIG. 12, in some embodiments, a pin coupling 258 may terminate the container coupling bolt 216 inside the adapter body 202. The pin coupling 258 may include a neck 262 attached to or integrally formed with the container coupling bolt 216, and a transverse, preferably cylindrical pin receiving portion 260 which terminates the neck 262. A pair of aligned or registering pin openings 254 may extend through the side plates 250 at a point which is longitudinally between the bolt opening 214 in the connecting plate 264 and the wheel axle openings 252. A pivot pin 256, formed along a central axis 296, may extend in the transverse direction y through the pin openings 254 and through the registering pin receiving portion 260 to pivotally mount the container connector 215 between the side plates 250 for purposes which will be hereinafter described.

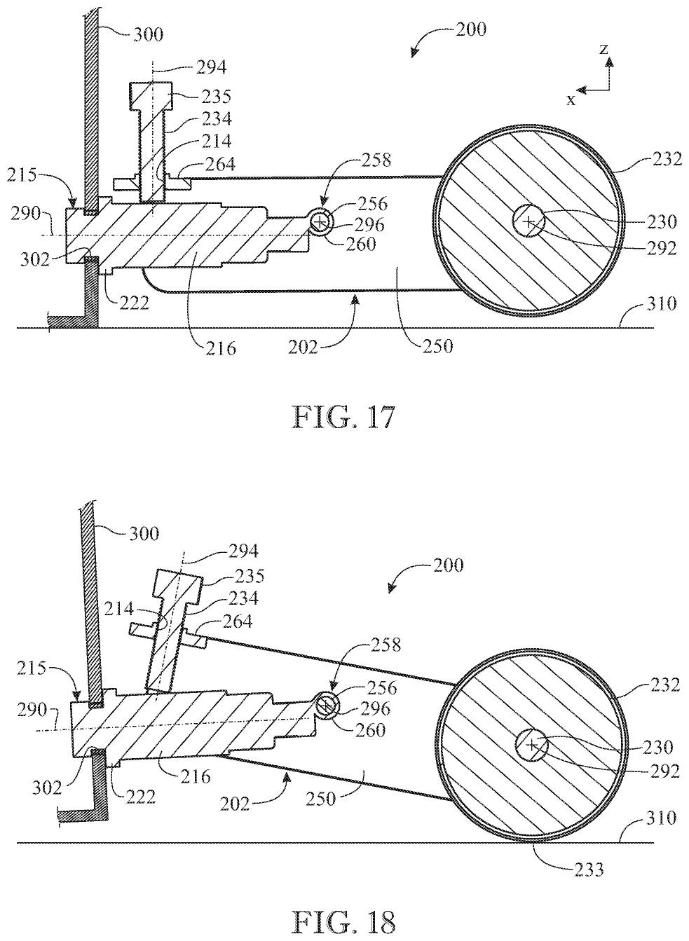

As particularly illustrated in FIGS. 17 and 18, the wheel-displacement bolt 234 may abut against the container connector 215. More specifically, the wheel-displacement bolt 234 may be threaded through the bolt opening 214 in the connecting plate 264 of the adapter body 202 and into engagement with the container coupling bolt 216 of the container connector 215. In the present embodiment, as shown in FIG. 17, the central axis 294 of the wheel-displacement bolt 234 is longitudinally spaced-apart with respect to the central axis 292 of the wheel axle 230, with the central axis 294 arranged frontward of the central axis 292. In turn, the central axis 296 of the pivot pin 256 is arranged longitudinally rearward of the central axis 294 of the wheel-displacement bolt 234 and frontward of the central axis 292 of the wheel axle 230. Thus, the pivot pin 256 forms an intermediate pivoting axis between the front and rear ends of the adapter body 202.

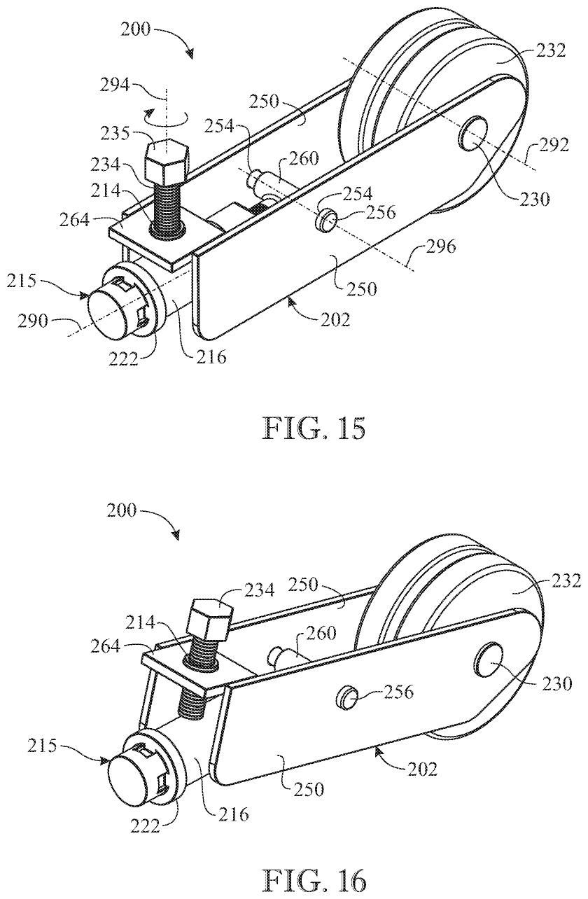

The wheel adapter 200 can be selectively deployed in the lowered position, as illustrated in FIGS. 15 and 17, typically by applying a torque on a head 235 of the wheel-displacement bolt 234 to cause a counterclockwise threading of the wheel-displacement bolt 234 outward of the bolt opening 214. This action lowers the front end of the adapter body 202 as the adapter body 202 pivots relative to the container coupling bolt 216 about the central axis 296 of the pivot pin 256. Alternatively, the wheel adapter 200 can be selectively deployed in the raised position, as illustrated in FIGS. 16 and 18, typically by applying a torque on a head 235 of the wheel-displacement bolt 234 to cause a clockwise threading of the wheel-displacement bolt 234 into the bolt opening 214 and against the container coupling bolt 216 of the container connector 215. This action raises the front end of the adapter body 202 as the adapter body 202 pivots relative to the container coupling bolt 216 about the central axis 296 of the pivot pin 256. In this raised position, a bottom end 233 of the wheel 232 provides a bottom end of the wheel adapter 200.

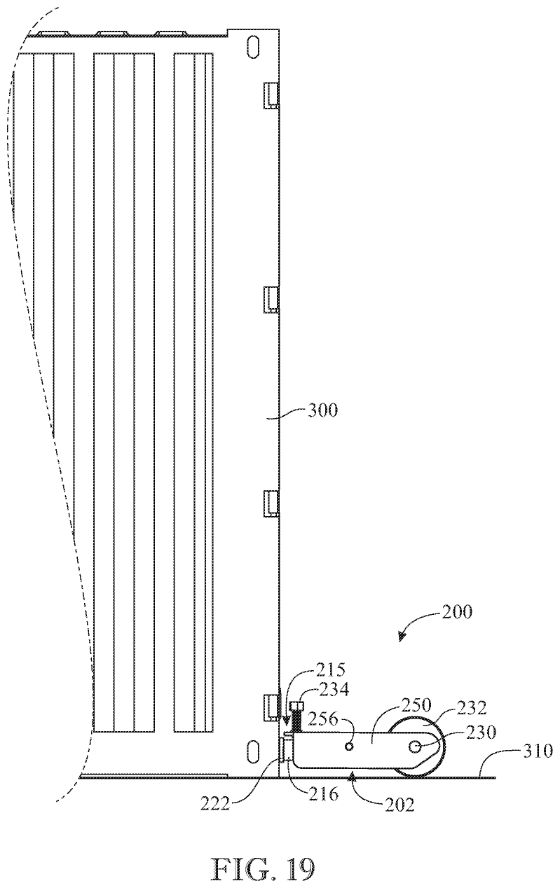

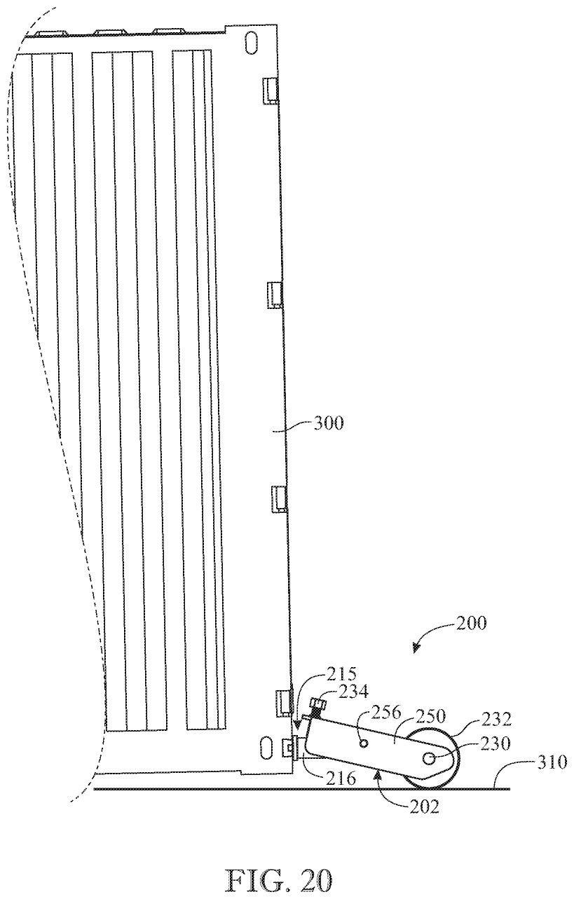

Application of the wheel adapter 200 may be as was heretofore described with respect to the wheel adapter 100 of FIGS. 1-10. As illustrated in FIGS. 11 and 17-20, in typical application, two or more wheel adapters 200 are attached to the cargo container 300. As illustrated in FIG. 19, each wheel adapter 200 may initially be deployed in the lowered position with the cargo container 300 resting on the support surface 310. The wheel-displacement bolt 234 may then be threaded in the clockwise direction into the bolt opening 214 and against the container coupling bolt 216 of the container connector 215, as illustrated in FIGS. 16 and 18, to raise the adapter body 202 relative to the wheel axle 130 and lift the cargo container 300 from the support surface 310, as illustrated in FIG. 20 while the bottom end 233 of the wheel 232 rests on the support surface 230, thus facilitating transport of the cargo container 300 over the support surface 310.

After the cargo container 300 has arrived at the intended destination, the wheel adapters 200 can again be deployed in the lowered position typically by counterclockwise rotation of the wheel-displacement bolt 234 in the adapter body 202 of each corresponding wheel adapter 200 to lower the cargo container 300 back onto the support surface 310, as illustrated in FIG. 19. The wheel adapters 200 can be detached from the cargo container 300 or remain in place on the cargo container 300 in anticipation of further short-range transport requirements.

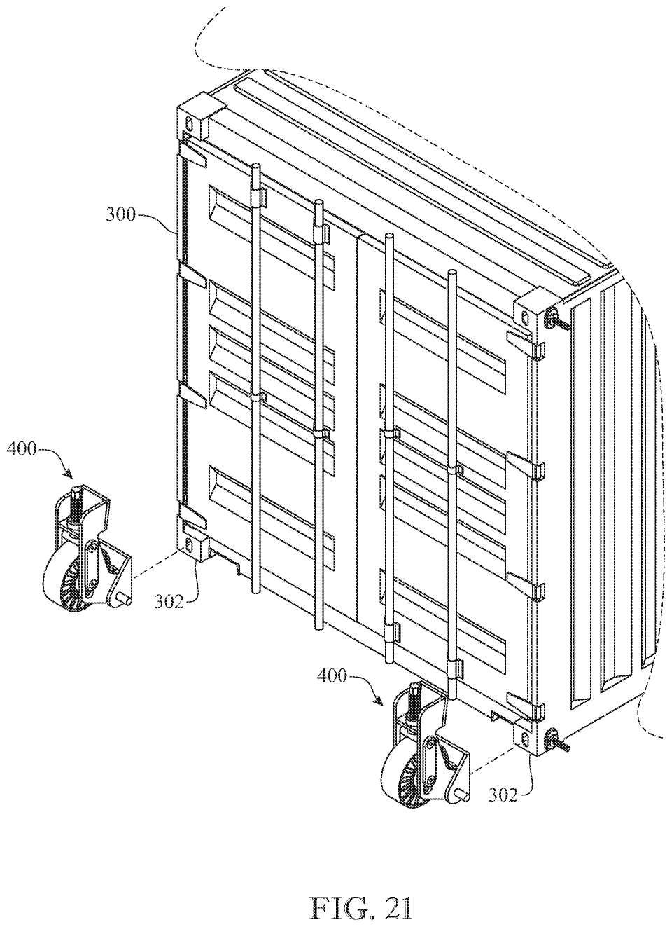

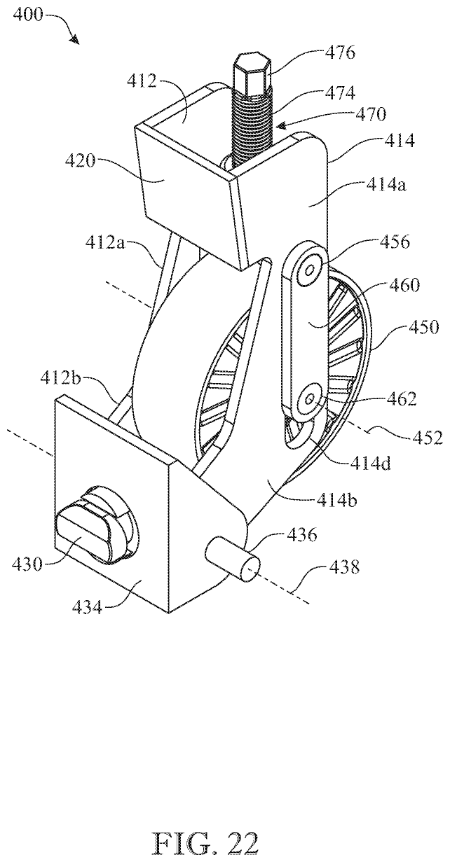

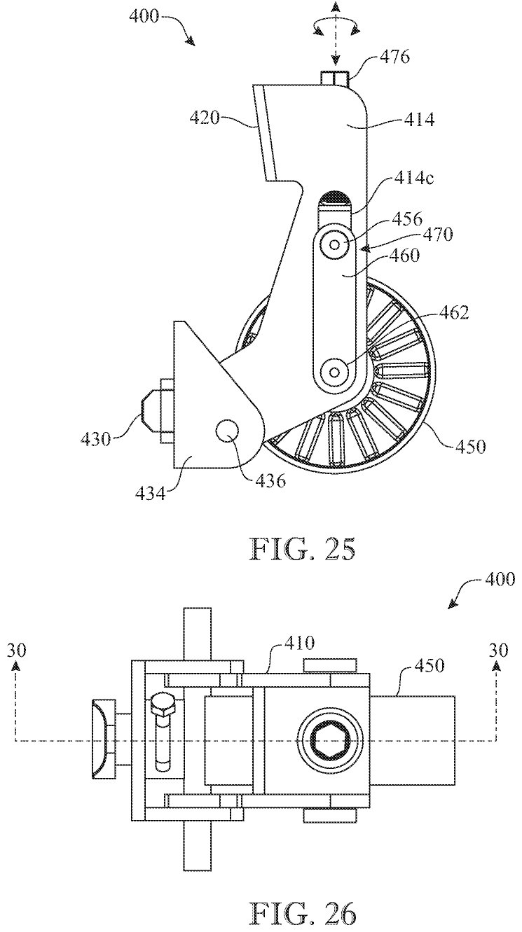

Referring next to FIGS. 21-31, a wheel adapter 400 is shown in accordance with a third illustrative embodiment of the invention. Similarly to the previous embodiments, the wheel adapter 400 allows for lifting a cargo container (for example, cargo container 300 shown in FIG. 21) and providing rolling mobility to the cargo container 300. As in the previous embodiments, the wheel adapter 400 comprises an adapter housing or body 410, a container connector 430 carried by and extending outward from the adapter body 410 to connect to the cargo container 300, and at least one wheel (a single wheel 450 in the present embodiment) which is rotatable relative to the adapter body 410 and provides rolling mobility to the wheel adapter 400. Also similarly to the previous embodiments, the wheel adapter 400 includes at least one pusher mechanism 470 engaging the adapter body 410 and configured to move the wheel 450 relative to the container connector 430 in order raise or lower the cargo container 300 relative to the wheel 450.

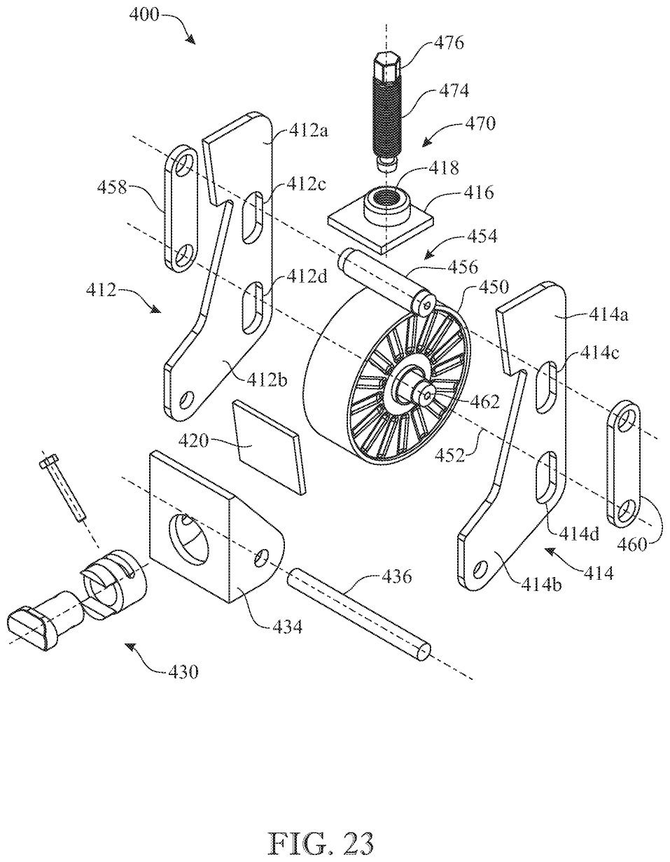

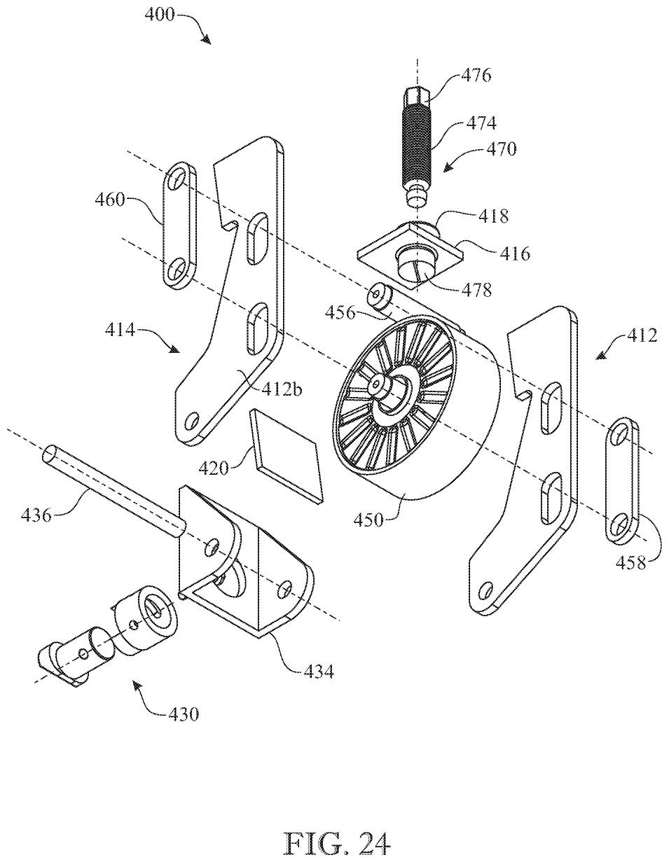

With initial reference to FIGS. 23 and 24, the adapter body 410 includes a first side plate 412 and an opposite, second side plate 414, which are spaced apart from one another to house the wheel 450 therebetween. In some embodiments, the first and second side plates 412, 414 can be generally L-shaped, as shown. The first and second side plates 412, 414 can include a first side plate portion 412a, 414a that extends generally upward from a rotation axis 452 of the wheel 450 and a second side plate portion 412b, 414b extending generally frontward of the rotation axis 452. A generally horizontal, transverse top plate 416 extends between and is non-movably attached to the first side plate portion 412a and the second side plate portion 414a and includes a threaded nut 418. A generally vertical, transverse front plate 420 extends between front ends of the first and second side plates 412, 414. The first side plate portions 412a, 414a, transverse top plate 416 and transverse front plate 420 form a first portion of the adapter body 410 (or first adapter body portion) extending generally upward from the wheel rotation axis 452, while the second side plate portions 412b, 414b form a second portion of the adapter body 410 (or second adapter body portion) which extends generally frontward from the wheel rotation axis 452.

The first side plate 412 further includes a top slot 412c and a bottom slot 412d extending therethrough. Similarly, the second side plate 414 includes a top slot 414c and a bottom slot 414d extending therethrough. The top slots 412c, 414c and bottom slots 412d, 414d are formed generally vertically and in longitudinal alignment.

Similarly to previous embodiments, the wheel 450 is carried by a wheel support 454. Specifically, the wheel support 454 is comprised of a crossbar 456, two opposite side links 458, 460 and a wheel shaft 462. The crossbar 456 extends between the first and second side plates 412, 414 and through the top slots 412c, 414c and is fixedly coupled to top openings formed in the side links 458, 460. In turn, the wheel shaft 462 extends through the bottom slots 412d, 414d and is coupled to bottom openings formed in the side links 458, 460 such that the wheel 450 is rotatable relative to the side links 458, 460 (for example, by having the wheel 450 pivotably carried by the wheel shaft 462 and the wheel shaft 462, in turn, non-movably affixed to the side links 458, 460). For purposes that will be hereinafter described, the crossbar 456 and wheel shaft 462 are configured to jointly move along the slots 412c, 412d, 414c, 414d, enabling the wheel support 454 (crossbar 456, side links 458, 460 and wheel shaft 462) to be translationally movable relative to the adapter body 410.

Similarly to the first embodiment of FIGS. 11-20, the container connector 430 of the present embodiment is pivotably attached to the adapter body 410. More specifically, as shown in FIGS. 23 and 24, the container connector 430 is carried by a pivotable support 434 that is pivotably coupled to the adapter body 410 by a pivot pin 436 defining a rotation axis 438. The rotation axis 438 is generally transverse and horizontal.

As mentioned heretofore, the wheel adapter 400 of the present embodiment includes at least one pusher mechanism 470 configured to move the wheel 450 relative to the container connector 430. More specifically, two pusher mechanisms 470 are provided in the present wheel adapter 400.

A first pusher mechanism 470 is provided by a threaded, wheel-displacement bolt 474 that is threadably coupled to the threaded nut 418 of the adapter body 410 and thus carried by the first adapter body portion. The wheel-displacement bolt 474 comprises a bolt head 476 for the application of a torque thereon to rotate the wheel-displacement bolt 474 about a central longitudinal axis of the wheel-displacement bolt 474. As best shown in FIGS. 21, 22 and 25, the bolt head 476 is accessible and operable from outside the wheel adapter 400. At a distal end of the wheel-displacement bolt 474, a pusher cover or cap 478 (FIG. 24) is non-movably coupled to the wheel-displacement bolt 474 and is also welded or otherwise affixed to the crossbar 456 such that the pusher cap 478, wheel-displacement bolt 474 and crossbar 456 are jointly movable. As best shown in FIGS. 25 and 27-29, the wheel-displacement bolt 474 and pusher cap 478 are in registration (i.e. aligned) with the wheel 450 such that threading and unthreading the wheel-displacement bolt 474 into and from the adapter body 410 moves the wheel relative to the adapter body 410, as will be described in greater detail hereinafter.

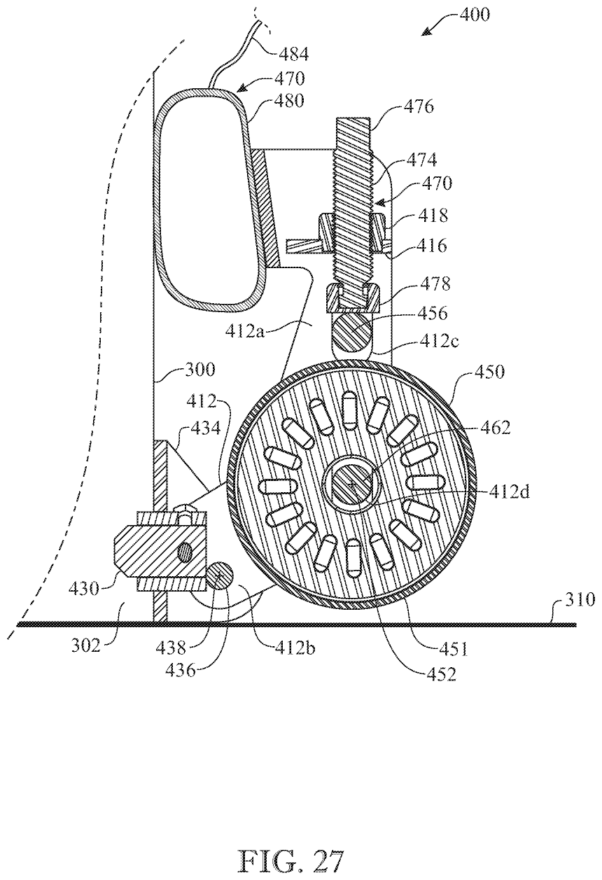

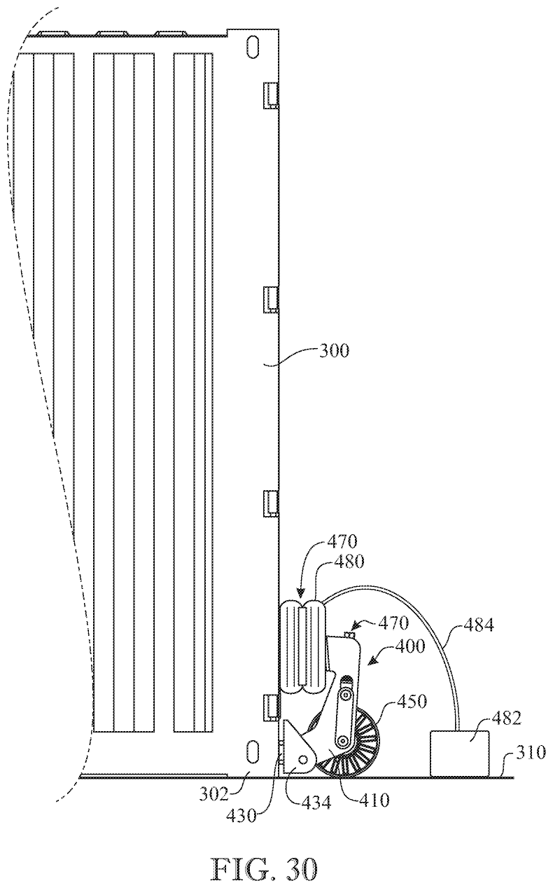

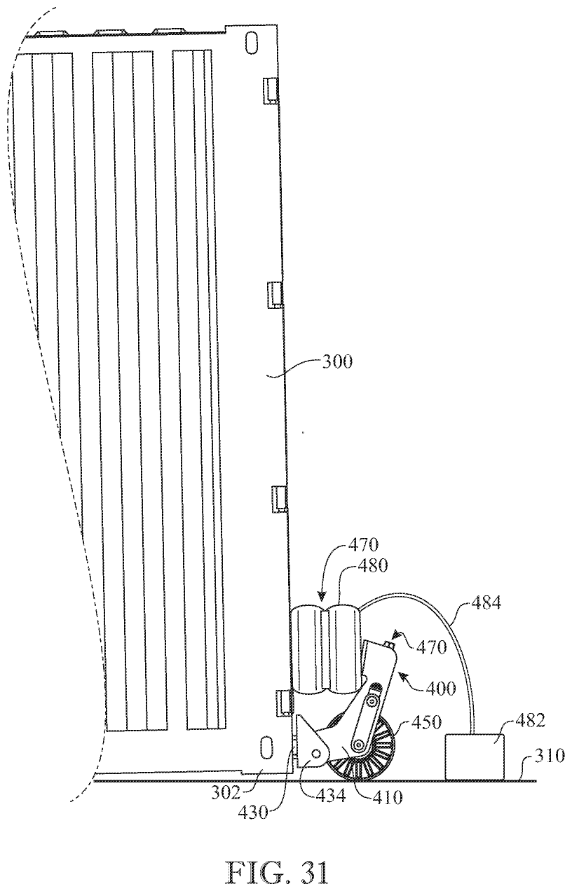

A second pusher mechanism 470 is provided by an inflatable and deflatable airbag unit 480, shown in FIGS. 27-31 (and omitted from FIGS. 21-26 for clarity). The airbag unit 480 is arranged in contact with the adapter body 410, and more specifically, in contact with the transverse front plate 420 of the adapter body 410. For instance, in some embodiments, the airbag unit 480 can be permanently or non-permanently (i.e. disconnectably) attached to the transverse front plate 420. In other embodiments, the airbag unit 480 may be separate from the adapter body 410 and placed between the transverse front plate 420 and container 300 and retained therewithin by friction. The airbag unit 480 can be in fluid communication with an air compressor or other gas or air source 482 (FIGS. 30 and 31) via a hose 484. As will be described in greater detail hereinafter, the inflatable and deflatable airbag unit 480 is configured to pivot the adapter body 410 relative to the wheel 450 to lower the wheel 450 in relation to the container connector 430 and thereby elevate the container 300 relative to the wheel 450.

An example of operation of the wheel adapter 400 will now be described with reference to FIGS. 21 and 27-31.

Initially, as shown in FIG. 21, two wheel adapters 400 are connected to two corresponding ISO connectors 302 arranged on opposite bottom rear corners of an ISO cargo container 300 by attaching the respective container connectors 430 of the wheel adapters 400 to the ISO connectors 302. Once the container connectors 430 have been coupled to the ISO connectors 302, the wheel adapter 400 may be arranged in a first position, shown in FIG. 27, in which a bottom 451 of the wheel 450 is at a raised or first vertical position relative to the container connector 430. In this first position, the wheel 450 can be in the air, with the bottom 451 of the wheel 450 not touching the ground or other support surface 310. Furthermore, in this first vertical position, the wheel 450 of the present embodiment is suspended from the wheel-displacement bolt 474, which is arranged in a relatively unthreaded position in which the wheel-displacement bolt 474 is slightly retracted outward (upward) from the adapter body 410 and has pulled the wheel 450 upward via the attached pusher cap 478, crossbar 458 and side links 458, 460 that interconnect the wheel shaft 462 to the wheel-displacement bolt 474. The wheel adapter 400 can remain in this first position, with the wheel 450 is elevated from the support surface 310 and the cargo container 300 in turn resting on the support surface 310, by different means such as, but not limited to, a sufficient friction at the pivotable connection between the pivotable support 343 of the container connector 430 and the first and second side plates 412, 414, or a mechanical or magnetic locking mechanism (not shown) securing the first and second side plates 412, 414 in the first position.

In order to provide rolling mobility to the cargo container 300, the pusher mechanism 474 is operated to switch the wheel adapter 400 to a second position in which the wheel 450 is moved to a second vertical position relative to the container connector 430 which is lower than the first vertical position of FIG. 27, and in which the bottom 451 of the wheel 450 contacts the support surface 310 while the cargo container 300 attached to the container connector 430 is lifted by the container connector 430. In the present embodiment, switching the wheel adapter 400 to said second position is carried out in a two-step sequence.

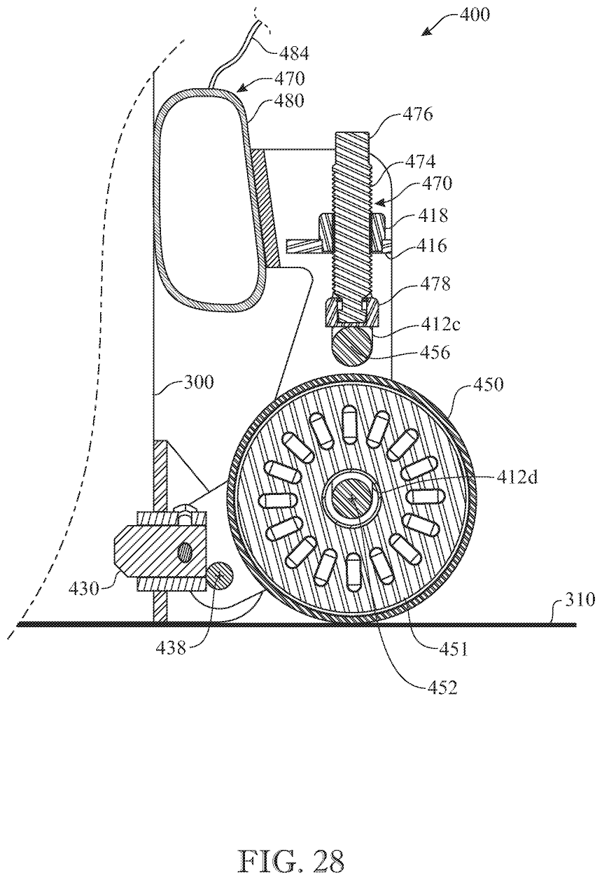

In a first step of the sequence, a torque is applied on the bolt head 476 to cause the wheel-displacement bolt 470 to rotate about its central longitudinal axis. Because the wheel-displacement bolt 470 is threaded into the non-movable threaded nut 418, rotation of the wheel-displacement bolt 470 causes the wheel-displacement bolt 470 to advance (translationally move downward) towards the ground or support surface 310. In consequence, the pusher cap 478, crossbar 456, side links 458, 460, wheel shaft 462 and wheel 450 are jointly translated downward towards the support surface 310. Separation between the airbag unit 480 and the bottom 451 of the wheel 450 is also thereby increased. By applying a sufficient torque on the bolt head 476, the bottom 451 of the wheel 450 can contact the support surface 310 as shown in FIGS. 28 and 30. Sufficient operation of the bolt head 476 will cause the wheel 450 to be tensioned against the support surface 310 and thus be better prepared for the next step.

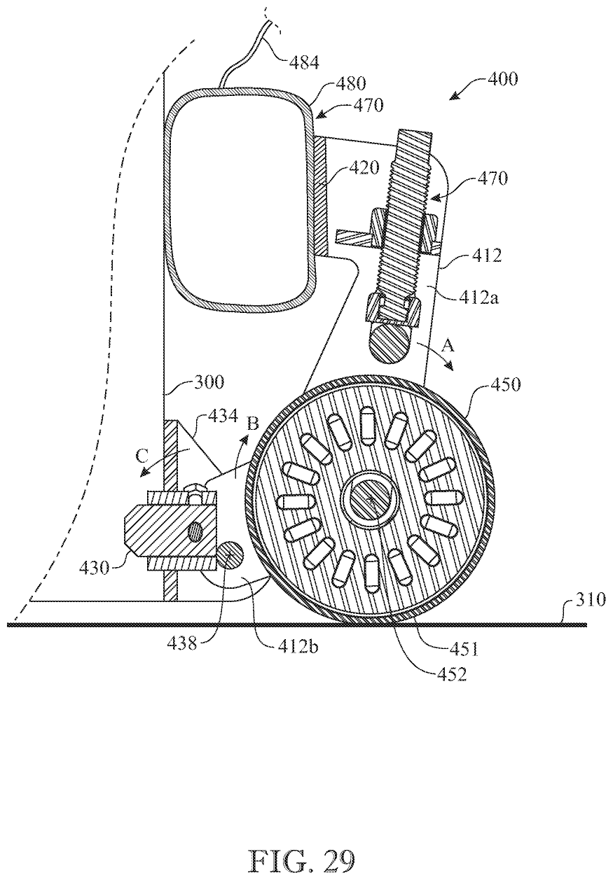

The illustration of FIG. 29 shows a second step of the sequence. Once the bottom 451 of the wheel 450 has contacted the support surface 310 and the wheel 450 is preferably tensioned against the support surface 310, air or gas is fed into the airbag unit 480 via the hose 484, causing the airbag unit 480 to inflate and exert a pressure on the wall of the cargo container 300 and on the transverse front plate 420 of the wheel adapter 400. Because the cargo container 300 is resting on the ground or support surface 310 and is relatively heavy, the pressure exerted by the inflating airbag unit 480 on the transverse front plate 420 causes the first adapter body portion and second adapter body portion to rotate jointly about rotation axis 452 as indicated by arrows A and B, respectively, while the wheel 450 remains on the ground or support surface 310. The rising second adapter body portion, and more specifically, the rising second side plate portions 412b, 414b of the side plates 412, 414, pull the pivotable support 434 upward, which in turn pulls the container connector 430 upward and causes the cargo container 300 to be lifted and separated from the ground or support surface 310, as shown in FIG. 29 and further shown in FIG. 31. Furthermore, by having the container connector 430 pivotably attached to the adapter body 410 about rotation axis 438, the container connector 430 may rotate about the rotation axis 438 while rising, as indicated by arrow C, to more efficiently raise the cargo container 300 in a generally vertical direction.

Once the cargo container 300 is raised from the ground and supported on wheels 450, it may be easily transported or moved to a different position using pulling or driving apparatus or vehicles which will not be described so as not to obscure the present invention. Finally, the cargo container 300 may once more be placed to rest on the ground or support surface 310 by carrying out the sequence described above in inverse order. I.e., the airbag unit 480 can first be deflated to rest the cargo container 300 on the support surface 310, and the wheel-displacement bolt 474 can then be unthreaded from the adapter body 410 to elevate the wheel 450 relative to the container connector 430 and thus lift the wheel 450 off the support surface 310 and bring the bottom 451 of the wheel 450 closer to the airbag unit 480.

Alternative embodiments are contemplated to those shown in the drawings and/or described heretofore. For example, it is contemplated that one or more wheels of the wheel adapter may be multidirectional wheels, i.e. wheels capable of imparting rolling mobility to the container in multiple directions and not just a longitudinal direction as shown in the present drawings. For instance, the one or more multidirectional wheels can include one or more swivel casters, spherical wheels, or the like. It is also contemplated that the pusher mechanisms described herein may alternatively or additionally include actuating mechanisms such as, but not limited to, a gas cylinder, a hydraulic system, a pneumatic system, an electric motor, etc.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A wheel adapter for lifting a cargo container and providing rolling mobility to the cargo container, the wheel adapter comprising:
an adapter body;
a container connector carried by and extending outward from the adapter body, the container connector configured for connection to a cargo container;
at least one wheel, rotatable relative to the adapter body; and
a pusher mechanism engaging the adapter body; wherein
the wheel adapter is configured to selectively and reversibly adopt the following positions by operating the pusher mechanism:
a first position, in which the bottom of the at least one wheel is at a first vertical position relative to the container connector, and
a second position, in which the bottom of the at least one wheel is at a second vertical position relative to the container connector which is lower than the first vertical position, and further in which the bottom of the at least one wheel contacts a ground or support surface.

2. The wheel adapter of claim 1, wherein the container connector is pivotably attached to the adapter body.

3. The wheel adapter of claim 1, wherein the container connector is non-movably attached to the adapter body.

4. The wheel adapter of claim 1, wherein the at least one wheel is rotatably coupled to and carried by a wheel support, and further wherein the wheel support is translationally movable relative to the adapter body and coupled to the pusher mechanism such that operation of the pusher mechanism causes the wheel adapter to switch between the first and second positions by translationally moving the wheel support and at least one wheel relative to the adapter body.

5. The wheel adapter of claim 1, wherein the at least one wheel is suspended from the pusher mechanism when the wheel adapter is in the first position.

6. The wheel adapter of claim 1, wherein the pusher mechanism comprises a wheel-displacement bolt threadably engaging the adapter body and comprising a bolt head for the application of a torque on the bolt head to rotate the wheel-displacement bolt.

7. The wheel adapter of claim 6, wherein the bolt head is accessible and operable from outside the wheel adapter.

8. The wheel adapter of claim 6, wherein the wheel-displacement bolt is registered with the at least one wheel such that threading the wheel-displacement bolt into the adapter body pushes the at least one wheel downward relative to the container connector to switch the wheel adapter to the second position.

9. The wheel adapter of claim 6, wherein the wheel-displacement bolt is coupled to the at least one wheel such that unthreading the wheel-displacement bolt from the adapter body elevates the at least one wheel relative to the container connector to switch the wheel adapter to the first position.

10. The wheel adapter of claim 6, wherein the container connector is pivotably attached to the adapter body about a first rotation axis, and the at least one wheel is rotatably carried by the adapter body about a second rotation axis arranged rearward of and parallel to the first rotation axis, and further wherein the wheel-displacement bolt is arranged frontward of the first rotation axis and configured to be threaded into the adapter body to push against the container connector and cause the adapter body to pivot about the first rotation axis such that the at least one wheel responsively descends in relation to the container connector to switch the wheel adapter to the second position.

11. The wheel adapter of claim 1, wherein the adapter body comprises a first adapter body portion extending upward from a rotation axis of the at least one wheel, and a second adapter body portion extending frontward of the rotation axis of the at least one wheel, wherein the pusher mechanism is carried by the first adapter body portion and the container connector is carried by the second adapter body portion.

12. The wheel adapter of claim 1, wherein the pusher mechanism comprises an inflatable and deflatable airbag unit arranged in contact with the adapter body, and further wherein the wheel adapter is configured to adopt the second position by inflating the airbag unit such that the airbag unit pushes and causes rotation of the adapter body relative to the at least one wheel, thereby causing the container connector to rotate carried by the adapter body and to elevate relative to the at least one wheel.

13. The wheel adapter of claim 12, the container connector is pivotably attached to the adapter body.

14. The wheel adapter of claim 13, wherein the pusher mechanism further comprises a wheel-displacement bolt threadably engaging the adapter body and comprising a bolt head for the application of a torque on the bolt head to rotate the wheel-displacement bolt, wherein the wheel-displacement bolt is configured to push the at least one wheel set downward thereby increasing separation between the airbag unit and the bottom of the at least one wheel.

15. The wheel adapter of claim 14, wherein the wheel-displacement bolt is further configured to pull the at least one wheel set upward thereby decreasing separation between the airbag unit and the bottom of the at least one wheel.

16. A wheel adapter for lifting a cargo container and providing rolling mobility to the cargo container, the wheel adapter comprising:
an adapter body;
a container connector carried by and extending outward from the adapter body, the container connector configured for connection to a cargo container;
at least one wheel, rotatable relative to the adapter body; and
a pusher mechanism engaging the adapter body, the pusher mechanism comprising a wheel-displacement bolt threadably engaging the adapter body and comprising a bolt head for the application of a torque on the bolt head to rotate the wheel-displacement bolt; wherein
the wheel adapter is configured to selectively and reversibly adopt the following positions by operating the pusher mechanism:
a first position, in which the wheel-displacement bolt is threaded away from the adapter body and the bottom of the at least one wheel is at a first vertical position relative to the container connector, and
a second position, in which the wheel-displacement bolt is threaded towards the bottom of the at least one wheel is at a second vertical position relative to the container connector which is lower than the first vertical position, and further in which the bottom of the at least one wheel contacts a ground or support surface.

17. The wheel adapter of claim 16, wherein the container connector is pivotably attached to the adapter body.

18. The wheel adapter of claim 16, wherein the container connector is non-movably attached to the adapter body.

19. The wheel adapter of claim 16, wherein the bolt head is accessible and operable from outside the wheel adapter.

20. A wheel adapter for lifting a cargo container and providing rolling mobility to the cargo container, the wheel adapter comprising:
an adapter body;
a container connector carried by and extending outward from the adapter body, the container connector configured for connection to a cargo container;
at least one wheel, rotatable relative to the adapter body; and
a pusher mechanism engaging the adapter body, the pusher mechanism comprising:
a wheel-displacement bolt threadably engaging the adapter body and comprising a bolt head, wherein the bolt head is accessible and operable from outside the wheel adapter for the application of a torque on the bolt head to rotate the wheel-displacement bolt, and
a selectively inflatable and deflatable airbag unit arrangeable in contact with the adapter body; wherein
the wheel adapter is configured to selectively and reversibly adopt the following positions by operating the pusher mechanism:
a first position, in which the wheel-displacement bolt is threaded away from the adapter body and the bottom of the at least one wheel is at a first vertical position relative to the container connector,
a second position, in which the wheel-displacement bolt is threaded towards the adapter body and the bottom of the at least one wheel is at a second vertical position relative to the container connector which is lower than the first vertical position, and further in which the bottom of the at least one wheel contacts a ground or support surface, and
a third position, in which the airbag unit is inflated causing the adapter body to pivot relative to the at least one wheel and the container connector to elevate relative to the at least one wheel such that the bottom of the at least one wheel is arranged at a third vertical position relative to the container connector which is lower than the second vertical position.
